(19) United States
(12) Patent Application Publication
(10) Pub. No.: US 2009/0216600 A1
(43) Pub. Date: Aug. 27, 2009

(54) SYSTEMS AND METHODS FOR ARRANGING A TRANSPORT TRANSACTION

(75) Inventor: Achim Hill, Boise, ID (US)

Correspondence Address: STOEL RIVES LLP - SLC, 201 SOUTH MAIN STREET, SUITE 1100, ONE UTAH CENTER, SALT LAKE CITY, UT, 84111, US

(73) Assignee: MONTISS LLC, Boise, ID (US)

(21) Appl. No.: 12/038,143

(22) Filed: Feb. 27, 2008

(51) Int. Cl. G06Q 10/00

(52) U.S. Cl. 705/9

(57) ABSTRACT

A requester may submit a request for transport comprising a set of transport preferences, which may include a desired starting point, ending point (e.g., destination), and pickup and/or delivery time. The transport preferences may also comprise a price and proximity thresholds indicating that non-conforming transport may be accepted within the supplied thresholds (e.g., not starting from exactly the desired starting point location, etc.). A group of registered users may be searched to find one or more transport providers (e.g., drivers) who may be available to provide the requested transport services. The set of drivers may be filtered based on one or more preferences of the requester. The requester preferences may relate to driver characteristics and/or driver vehicle characteristics.

### TECHNICAL FIELD

This disclosure relates to systems and methods for arranging transport transactions between a transport requester and a transport provider according to one or more requester preferences relating to a driver characteristic and/or a driver vehicle characteristic.

### BRIEF DESCRIPTION OF THE DRAWINGS

FIG. 1 is a block diagram of a system for arranging a transport transaction;

FIG. 2 is a flow diagram of an embodiment of a method for establishing a user profile comprising requester and/or driver preferences in a transport transaction service;

FIG. 3 is a flow diagram on an embodiment of a method for performing a transport transaction;

FIG. 4 depicts an application and user interface to allow a user to establish one or more requester preferences; and

FIG. 5 depicts an application and user interface to allow a user to establish one or more driver preferences.

### DETAILED DESCRIPTION OF PREFERRED EMBODIMENTS

Each day millions of people and goods travel across the country from one location to another. Increasing energy prices and general lack of affordable alternatives have resulted in increasing transportation costs. Metropolitan areas have seen an increase in traffic congestion and, as a result, many have established commuter lanes and van pool services. Traffic congestion as well as the cost of transportation remain incentives for people to share transport (e.g., carpool with one another).

There are, however, significant difficulties in setting up carpooling or other transportation arrangements between requesters (e.g., passengers, shippers) and providers (e.g., drivers, couriers). For example, there are few means available to conveniently match transport routes and schedules between transport providers and transport requesters. In addition, there is a lack of an easy-to-use contractual framework for provisioning (e.g., providing and paying for) private transport services, such as determining a cost for the transport and transferring payment from the passenger to the driver. While there may be many potential private and commercial providers for each transport requester, there is no mechanism for the requester to optimize the transaction conditions (e.g., get the lowest rate for the transport, or find a driver with a similar schedule and interests).

Moreover, transportation requesters may have little or no information about the provider in the transaction. Many potential passengers may be understandably hesitant to accept transport from a provider they know little or nothing about. Similarly, transport providers may be understandably reluctant to provide transportation services to a passenger they know little or nothing about. Furthermore, both requesters and providers may be hesitant to provide personal information about themselves to an unknown party due to privacy concerns, the potential for identity theft, and the like.

These issues may be addressed by providing systems and methods to conveniently and securely connect those in need of transportation services with transportation service providers capable of providing the requested transport services according to a set of transport transaction specific preferences, including a preferred transport starting point, a preferred transport ending point, a preferred pickup or delivery time, and the like. The systems and methods disclosed herein may provide an added level of assurance to requesters and providers by allowing both parties to predicate acceptance of a travel transaction on one or more preferences that may be unrelated to the particular transport transaction (e.g., the starting point, ending point, price, and the like) and may help passengers and drivers feel more secure in entering into a transport transaction with people they may not be personally acquainted with, while preserving their privacy. As will be discussed below, these requester preferences may relate to one or more driver characteristics and/or one or more driver vehicle characteristics.

In one embodiment, a requester may create a passenger profile comprising one or more preferences. As used herein, a requester preference may refer to any preference that is not directly related to a particular transport transaction and relates to a driver characteristic and/or a driver vehicle characteristic.

An example of preferences related to a particular transport transaction include the starting point for a travel transaction (e.g., an address or location coordinate), an ending point, a pickup and/or delivery time, pricing, and transport route.

By contrast, requester preferences may not be directly related to a particular transport transaction. Requester preferences may relate to driver characteristics and/or driver vehicle characteristics. For example, requester preferences related to a driver characteristic may include, but are not limited to driver demographic characteristics, such as a gender of the driver, a race of the driver, an age of a driver, an educational level of the driver, a professional status (e.g., education level, occupation type, or the like) of the driver, and the like. In addition, driver characteristics may include, but are not limited to a criminal record of the driver, a credit report of the driver, an interest (e.g., science fiction, reality TV, or the like) or hobby of the driver, the political persuasion of the driver, a religion of the driver, driver insurance coverage and limits, driver driving record, and the like. Requester preferences related to a driver vehicle characteristic may include, but are not limited to: a vehicle type (e.g., body style, such as sport utility vehicle (SUV), truck, or the like); a vehicle emissions level (e.g., whether the vehicle is a low emissions vehicle; an engine type of the vehicle (e.g., diesel, hybrid, etc.); a fuel efficiency rating of the vehicle; a vehicle make, model, and/or year; a vehicle color; vehicle options (e.g., air conditioning, tinted windows, etc.); the availability of GPS and/or location monitoring systems in the vehicle; the availability of navigation systems in the vehicle (e.g., GPS and/or OnStar®); and the like.

Similarly, transportation providers (e.g., drivers) may establish driver preferences relating to requesters to control the type of requesters to which the driver is willing to provide transportation services. The driver preferences may relate to passenger demographic characteristics, such as a passenger age, gender, race, education level, occupation, and the like. In addition, passenger characteristics may relate to: passenger interests, hobbies, religion, political persuasion, credit rating, criminal record, and the like. In addition, where the driver may transport of goods and/or documents, the driver may establish preferences relating to the goods he/she is willing to transport. For example, the driver may indicate that he/she is unable to transport hazardous materials, or the like.

These driver preferences may provide an added degree of confidence to both the requester and provider in a particular transport transaction. For example, a young female requester seeking personal transport services (e.g., as a passenger) may feel uncomfortable accepting transport from an older, anonymous male driver. The use of the requester preferences may assure that she is matched with a driver of her preferred gender in an acceptable age range. Similarly, passengers and drivers may prefer to ride with others who share comparable views and professional backgrounds, particularly in a commuting context. Preferences relating to passenger or driver interests, hobbies, religion, political persuasion, and the like may be used to make an acceptable match.

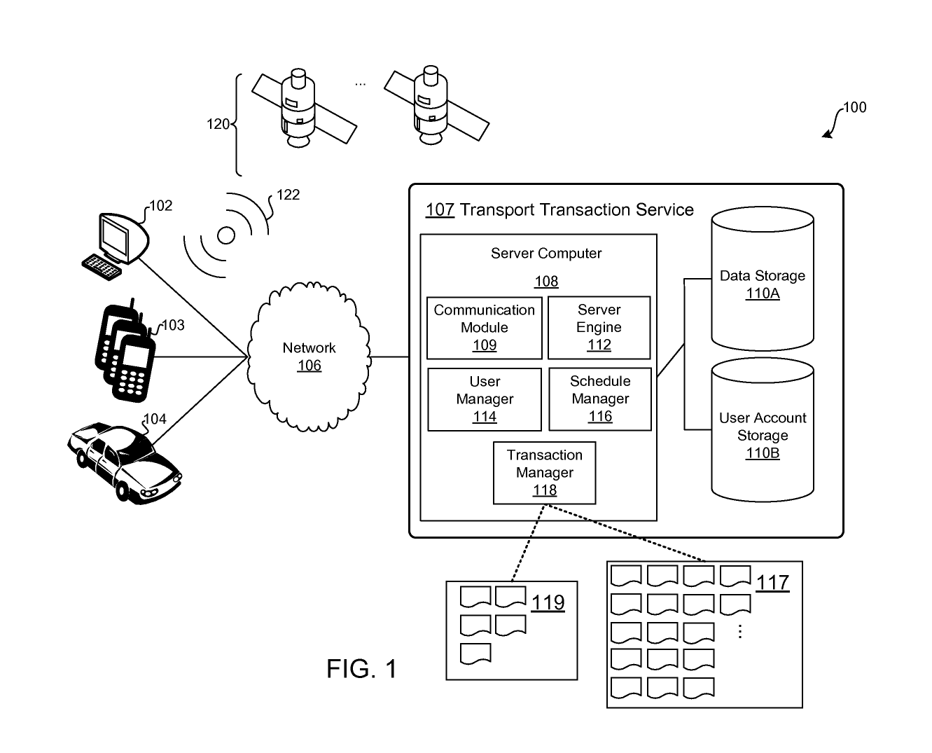

Aspects of the teachings of this disclosure may be practiced in a variety of computing environments. FIG. 1 depicts a block diagram of a system 100 for arranging a transport transaction according to one embodiment. The system 100 may be implemented in the context of a distributed network environment comprising one or computing devices 102, mobile computing devices 103, and vehicle computing devices 104 communicatively coupled to an asset transport service 107 running on a server computer 108 via a network 106.

The computing devices 102 may comprise any general or special purpose computing device known in the art. As such, the computing devices 102 may comprise a general purpose, personal computer running an operating system, such as Microsoft® Windows, Linux, Apple OSX®, Linux®, or the like.

The mobile computing devices 103 may comprise any type of mobile computing devices known in the art including, but not limited to a cell phone, a smart phone, a personal digital assistant (PDA) device, an electronic organizer, a global positioning system (GPS) receiver, a navigation device, a media player (e.g., Apple iPod®), or the like. The mobile computing devices 103 may comprise a network interface to allow the devices 103 to communicate with other computing devices via the network 106.

The vehicular computing devices 104 may comprise a computing device that is integrated into a vehicle. As such, the vehicular computing devices 104 may comprise a general or special purpose computing device, such as Microsoft Sync®, OnStar®, or the like. The vehicular computing devices 104 may comprise a network interface to communicatively couple devices 104 to other computing devices via network 106.

The user computing devices 102, 103, and 104 may be capable of transmitting location coordinates to the transport service 107. In some embodiments, the user computing devices 102, 103, and/or 104 may be communicatively coupled to a satellite navigation system 120 via a satellite link 122. One example of a satellite navigation system is a Global Positioning System (GPS) system comprising one or multiple GPS positioning satellites 120. Alternatively, the devices 102, 103, and/or 104 may automatically determine their location using the network 106. For example, wireless network access points may comprise location information that may provide general location information to the device 102, 103, and/or 104. In addition, where multiple wireless access points are available, position of the device may be obtained using triangulation or some other method. The devices 102, 103, and/or 104 may be configured to transmit location information to the transport transaction service 107 via the network 106.

The system 100 may comprise a transport transaction service 107 running on a server computer 108, which may be communicatively coupled to the computing devices 102, 103, and 104 via the network 106. The network 106 may comprise routing, addressing, and storage services to allow the computing devices 102, 103, and 104 and the server computer 108 to communicate data, such as web pages, text content, audio content, video content, graphic content, and/or multimedia content therebetween. The network 106 may comprise a private network and/or a virtual private network (VPN). The network 106 may comprise any communication protocol and/or infrastructure known in the art including, wireless network communication (e.g., IEEE 802.11a-n), wired connections (e.g., Ethernet or the like), cellular network communication (e.g., Edge®, G3, or the like), a public switched telephone network (PSTN), or the like. In addition, the network 106 may comprise combinations of various network protocols and/or infrastructures.

The network 106 may comprise a client-server architecture, in which a computer, such as server 108, is dedicated to serving other client user computing devices 102, 103, and 104, or it may have other architectures, such as a peer-to-peer (P2P), in which one or more user computing devices 102, 103, and 104 serve simultaneously as servers and clients. In addition, although FIG. 1 depicts a single server computer 108, one skilled in the art would recognize that the transport transaction service 107 may comprise multiple server computers 108 (e.g., in a clustering and/or load sharing configuration). As such, this disclosure should not be read as limited to a single server computer 108.

The server computer 108 may be communicatively coupled to network 106 by communication module 109. Communication module 109 may comprise a wired and/or wireless network interface (not shown) capable of communicating using a networking and/or communication protocol supported by network 106 and/or user computing devices 102, 103, and 104.

Server 108 may comprise and/or be communicatively coupled to a data storage module 110A. Data storage module 110A may comprise one or more databases, extensible markup language (XML) data stores, file systems, X.509 directories, lightweight directory access protocol (LDAP) directories, and/or any other data storage and/or retrieval systems known in the art. Data storage module 110A may comprise web pages and associated content to be transmitted to one or more of computing devices 102, 103, and 104 via network 106.

The server 108 may comprise a server engine 112, a user manager 114, a schedule manager 116, and a transaction manager 118. The server engine 112 may perform processing and operating system level tasks including, but not limited to: managing memory access and/or persistent storage systems of server computer 108, managing connections to the user computing devices 102, 103, and 104 over the network 106, and the like. The server engine 112 may manage connections to/from the user computing devices 102 using the communication module 109.

The user manager 114 may allow users to register with the transport transaction service 107. Users may communicate with the transport transaction service 107 using the computing devices 102, 103, and 104 via the network 106 to the server computer 108. User registration requests may be received by the user manager 114 and stored in a user account storage module 110B. User account information may comprise a user name, contact information, preferences (including requester and/or provider preferences), transport scheduling information (e.g., the commuter route of the user), payment information, and the like. The user account information may also comprise driver availability information, indicating the locations and times the driver is generally available to provide transport services.

A transaction manager 118 may be used to facilitate transport transactions between users seeking transportation services and users available to provide transportation services. The transaction manager 118 may receive requests for transportation services from one or more requesters via the computing devices 102, 103, and 104 and may connect the transport requests with one or more registered transport providers the in database 110A.

The requests for transport services may comprise one or more transport transaction related preferences. These preferences may include a desired starting point, a desired ending point, and a desired pickup and/or delivery time (e.g., where from, where to, and when). Using this information, the transaction manager 118 may identify one or more drivers 117 who may be available to provide the requested transport. In one embodiment, this determining may comprise searching the user account data store 110B to identify one or more users who can be in the vicinity of the starting point at the desired pickup time and/or arrive at the ending point by the desired delivery time. Where real-time transportation is requested (e.g., the transport time is “now” or within a short time window), real time driver location information provided by, inter alia, a GPS navigation system in a mobile device 103 and/or vehicular computing device 104 may be used to identify drivers who are available to provide the transport services. Alternatively, one or more registered transport providers may manually update their location information by transmitting an address and/or location coordinate to the transport transaction service 107. The group of providers available to provide the requested transportation transaction may comprise a first set of drivers 117.

The transaction manager 118 may filter the set of drivers 117 according to one or more preferences of the requester and driver. As discussed above, the preferences may be associated with a user account and stored in the user account storage module 110B. These preferences may allow requesters and providers to be more confident in receiving and providing transportation services to unknown, anonymous parties.

The transaction manager 118 may compare the drivers in the first set of drivers 117 to one or more requester preferences. Alternatively or in addition, the transaction manager 118 may compare one of more driver preferences of each of the drivers in the first set of drivers 117 to a user profile of the requester. These comparisons may result in a second set of drivers 119. The members in the second set of drivers 119 may comprise those drivers who conform to the requester's preferences and, in one configuration, whose driver preferences are compatible with the passenger.

The drivers in the second set of drivers 119 may comprise an ordered or un-ordered list of drivers who can be available to provide the requested transportation and who have mutually compatible preferences. The second set of drivers 119 may be ordered based on non-mandatory preferences. For example, a preference of the requester, such as vehicle type (e.g., prefer drivers who drive “clean” or “hybrid” vehicles), or the like may be used to order the second set of drivers 119.

The transport transaction may be offered one or more of the drivers in the second set of drivers 119. In one configuration, the transport transaction may be offered to all of the drivers in the second set of drivers 119. Alternatively, the transport transaction may be offered to only one (or a subset) of the second set of drivers 119 according to various criteria. For instance, the transport transaction may be initially offered to the closest driver in the second set of drivers 119 and only offered to other drivers if the first driver declines. In other embodiments, the transport transaction may be initially offered to one or more drivers with the largest number of similarities between the passenger's and driver's profiles. In still other embodiments, one or more drivers may pay for the privilege of being contacted first or having a higher priority than other drivers.

Offering a transport transaction to a driver may comprise transmitting a message to the driver via network 106 to provide the driver with the relevant details of the transport transaction, such as the starting point, the ending point, and the pickup and/or delivery time. The driver may accept the transaction by posting a reply to the transport transaction service via network 106. Once the reply has been received, the transport transaction service may close the transaction and retract any outstanding offers to other drivers in the second set of drivers 119. Alternatively, where a bidding model is used, a plurality of drivers in the second set of drivers 119 may be offered the transaction. One or more drivers may respond with a bid price for the transport. The service may accept the lowest bid for the service.

After the transport transaction has been established, the transport transaction service 107 may send a message to the requester informing him/her that the transaction was accepted by a provider. In some embodiments, a requester may indicate that the starting point, ending point, and pickup and/or delivery time are flexible within certain thresholds. This may allow the transaction to be modified (within the thresholds) by the driver. As such, the transport transaction confirmation message may comprise the actual starting point, ending point, and pickup and/or delivery time. In addition, the message may comprise payment information, such as how much the transport will cost, how payment is to be made, and the like. Moreover, the message may include driver identification data. For example, a user account of a driver may include data to allow users to identify the driver, such as a photo of the driver's vehicle, a photo of the driver, a license plate number of the vehicle, or the like. This driver identifying information may be transmitted to the requester to help the requester identify the driver and/or the driver's vehicle at the pickup time. Depending upon user preferences, additional information about the requester and/or provider may be exchanged. This information may include the passenger and driver name, various information from the driver's and passenger's profiles (likes, dislikes, hobbies), and the like.

The transport transaction service 107 may be configured to provide one or more transaction reminder messages to the requester and provider as the time for transport approaches. Like the messages described above, the transaction reminder messages may provide the transport transaction staring point, ending point, and pickup and/or delivery time. In addition, the reminder messages may include the identification data of the passenger and drivers (e.g., photo of the driver's vehicle, license plate number, make and model description, or the like).

The reminder and confirmation messages described above may be delivered to the computing devices 102, 103, and 104 communicatively coupled to network 106. Alternatively, the messages may be delivered to a non-network 106 connected device, such as a voice telephone or the like, SMS cell phone message, or the like.

In addition to the reminder and confirmation messages, the requester may be provided with real-time updates of the driver's location during a time window of the transport transaction. As discussed above, a driver using the system 100 may possess a mobile computing device 103 and/or vehicular computer system 104. These devices may be capable of providing real-time location information to transport transaction service 107. The requester may be provided with this real-time location information to view the driver's progress on a map as he/she approaches the starting point for the transport transaction. In addition, transport transaction service 107 may be configured to detect when the driver comes within a threshold distance of the starting point (e.g., within a proximity geo fence to the starting point). Upon detecting the driver's proximity to the starting point, an alert message may be transmitted to the requester. This message may be used by the requester to know that the driver is nearing the starting point and that the driver will likely arrive shortly.

In addition, if the transport service is requested for a third-party (e.g., a parent arranging for the transport for a child) and/or is for the transport of goods or documents, the requester may be provided with means for monitoring the progress of the provider during the transaction. As discussed above, this may be done by monitoring a location of the driver via a GPS unit, wireless network connection, cellular telephone network, or the like. Alternatively, the driver may be required to manually update his/her location with the system to allow the system to track the driver's progress.

The server computer 108, the data storage module 110A, and the user accounts module 110B may comprise security measures to inhibit malicious attacks thereon, and to preserve integrity of the messages and data stored therein. Such measures may include, but are not limited to firewall systems, secure socket layer (SSL) communication, user authentication, public key infrastructure (PKI) authentication, password protection schemes, data encryption, and the like.

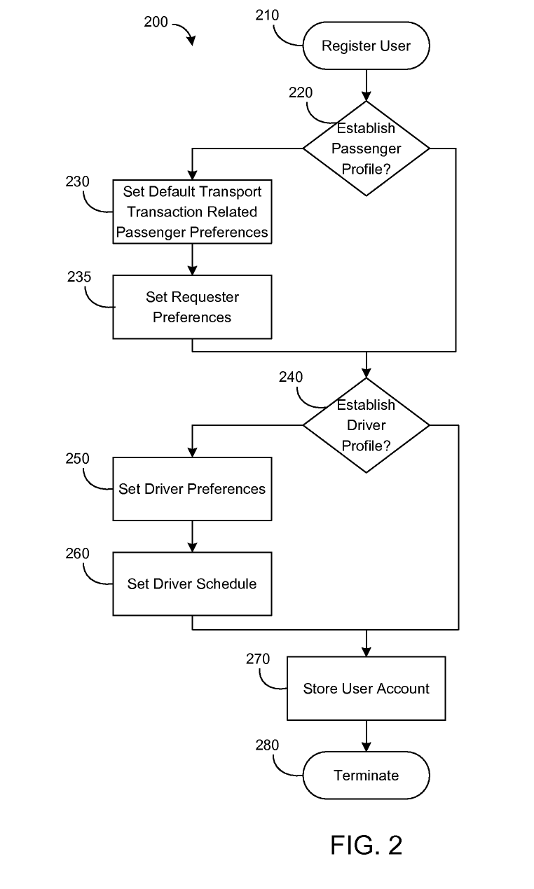

FIG. 2 shows a flow diagram of one embodiment 200 of a method for facilitating a transport transaction. At step 210, a user may register with a transport transaction service. As discussed above, registering with the service may comprise providing a user name, password, contact information, payment information, and the like. In addition, the user may be prompted to provide demographic information, such as the user's age, gender, interests, and the like. This demographic information may be used to match the user with other users of the system using preferences. In addition to the demographic information, information relating to the user's insurance coverage, criminal record, driving record, and the like may be provided. This information may be kept confidential and may be independently verified by a third-party.

At step 220, the flow may determine whether the user would like to receive transport services through the system (e.g., act as a passenger in a transport transaction). If so, the flow may continue at step 230; otherwise, the flow may continue at step 240.

At step 230, the new user may establish one or more default transport related passenger preferences. These preferences may relate to issues relevant to a particular transport transaction and may include, payment methods, a default starting location (e.g., the user's home area), and the like.

At step 235, the new user may establish one or more requester preferences. As discussed above, these preferences may not be directly related to any particular transport transaction, but instead, may allow the user to control the type of drivers and/or passengers the user will interact with on the system.

The requester preferences provided at step 235 may not be directly related to a particular transport transaction. For example, requester preferences may be related to a driver characteristic and/or a driver vehicle characteristic. As such, requester preferences may include, but are not limited to: driver demographic characteristics, such as a gender of the driver, an age of a driver, an educational level of the driver, a professional status (e.g., education level, occupation type, or the like) of the driver, and the like. In addition, driver characteristics may include, but are not limited to: a criminal record of the driver, a credit report of the driver, an interest or hobby of the driver, the political persuasion of the driver, a religion of the driver, driver insurance coverage and limits, driver driving record, and the like. Requester preferences related to a driver vehicle characteristic may include, but are not limited to: a vehicle type (e.g., body style, such as sport utility vehicle (SUV), truck, or the like); a vehicle emissions level (e.g., whether the vehicle is a low emissions vehicle; an engine type of the vehicle (e.g., diesel, hybrid, etc.); a fuel efficiency rating of the vehicle; a vehicle make, model, and/or year; a vehicle color; vehicle options (e.g., air conditioning, tinted windows, etc.); the availability of GPS and/or location monitoring systems in the vehicle; the availability of navigation systems in the vehicle (e.g., GPS and/or OnStar®); and the like.

The requester preferences of step 235 may be marked as mandatory or non-mandatory. A mandatory preference may be required in order to form a match between the user and a transport services provider. A non-mandatory preference may be used to order one or more otherwise conforming drivers. In some embodiments, non-mandatory preferences may comprise weights to determine a relative importance of the non-mandatory preferences.

In addition, preferences may be marked as requiring third-party verification. In some embodiments, aspects of the user profile may comprise information that may be verified by a third-party (e.g., by the transport transaction service, government agency, or the like). If a preference is marked as requiring verification, it may only match if the corresponding driver (or passenger) profile has been verified by a third-party.

At step 240, the flow may determine whether the user would like to provide transport services in the system (e.g., act as a driver in a transport transaction). If so, the flow may continue to step 250; otherwise, the flow may continue at step 270.

At step 250, the user may establish one or more driver preferences. These preferences may allow a driver to specify characteristics about passengers the driver is willing to offer transport services to and may be similar to the passenger preferences discussed above. Although the driver preferences may be similar to the requester preferences established at step 220, the driver preferences may be somewhat broader (e.g., allow matches from a wider variety of users). This may be because the driver may be more comfortable in providing transport services to users of the system than accepting transport services from members of the system (e.g., because the driver generally has more control in the transaction than a passenger). In addition, the preferences provided at step 250 may comprise preferences relating to the transport of goods and/or documents.

At step 260, the user may establish a driver schedule. A driver schedule may indicate the general locations and travel times of the driver. For instance, for an individual, the driver schedule may comprise a commuting schedule of the driver (e.g., Monday through Wednesday, leave suburb B at 7:00 a.m. to travel downtown, and leave downtown at 6:00 p.m.). Driver schedules may vary depending upon the weekday and time of year. As such, driver schedules may be specified on a per-calendar day basis and/or may comprise a recurring, regular schedule. In addition, some drivers may specify a real-time, location-based availability. In this case, the driver may periodically update his/her location and availability status with the system throughout the day using, for example, a GPS unit, a cell phone, manually, or the like. The driver may be called upon to provide transport services based on the driver's location and availability status. Alternatively, a driver may wish to provide transport services over a broad area and, accordingly, may provide a broad range of available locations and availability times.

In some embodiments, the driver schedule may comprise multiple forms of transport services. For example, the driver may be capable of providing transport via boat, aircraft, or the like. As such, the driver may be able to provide transport services over a large range of distances and locales. As such, this disclosure should not be read as limited to transport by surface vehicles (e.g., cars or trucks), but may encompass air travel, space travel, water travel, or the like.

Although not shown in FIG. 2, the user may establish other preferences, such as courier preferences. The courier preferences may be used for arranging the transport of goods and/or documents using the transport transaction service. The courier preferences may be different than either the passenger or the driver preferences; for example, in a courier context, a user may care little about the demographics of the driver.

At step 270, the user profile may be stored in a user account storage system (e.g., user account storage 110B of FIG. 1). At step 280, the flow may terminate.

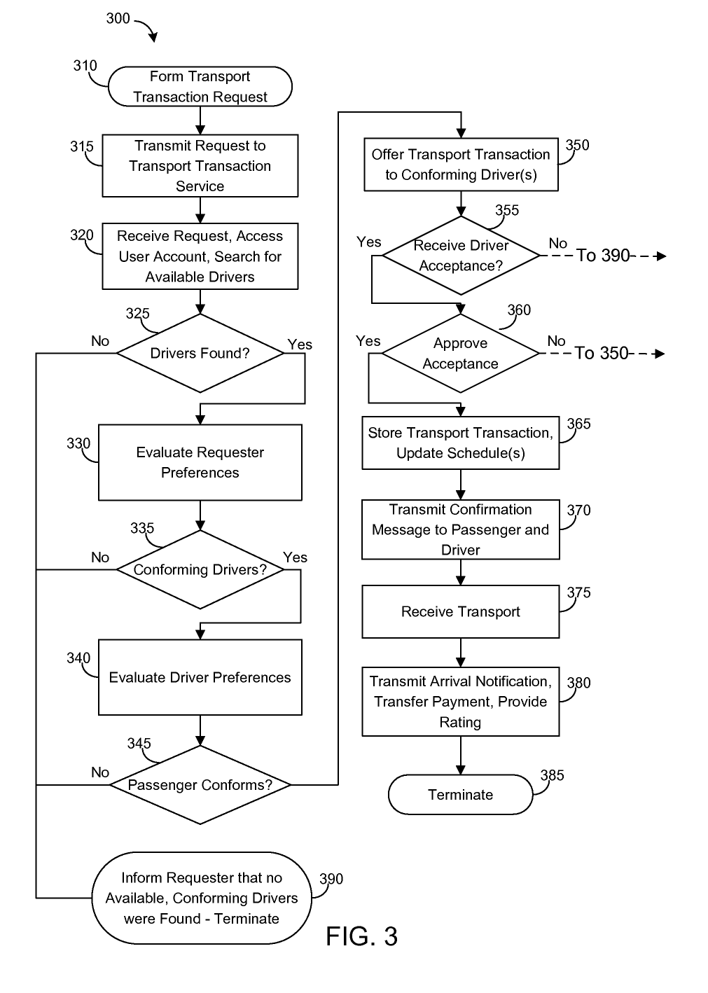

FIG. 3 depicts a flow diagram of one embodiment of a method for establishing a transport transaction between a requester and a transport provider. In FIG. 3 the requester is requesting personal transport (e.g., the requester is a passenger) from a provider (e.g., drivers). However, other transport service scenarios, such as courier services, taxi services, transport for a third-party, and the like could be arranged using a similar method 300. As such, method 300 should not be read as limited to arranging personal transport between a passenger and a driver.

At step 310, a user may form a transport transaction request to be transmitted to a transport transaction service. The request of step 310 may comprise travel transaction related preferences. These transaction related preferences may indicate a desired starting point for the transport, a desired ending point for the transport, and a desired pickup and/or delivery time for the transport. In some embodiments, the request may also comprise a price the requester is willing to pay for the transport. For example, the transport transaction request could request transport from a location A to a location B at a time T for payment of no more than price P or price P per mile.

In addition, the transport transaction preferences of the request may comprise thresholds related to the request. For example, the request may indicate that the user is willing to accept transport that starts within a threshold distance of his/her desired starting point location; within a threshold distance of his/her desired ending point location; within a threshold time of the desired pickup and/or delivery time; and/or within a threshold price of the desired payment amount for the transport. This may allow the passenger to be matched to a wider array of drivers in the system. For example, the thresholds may indicate that the passenger is willing to walk up to 200 meters to the starting point, up to 200 meters from the ending point, accept transport within one-half hour of the requested pickup time, and/or within X dollars of the desired price. These thresholds may be provided by the passenger on a per-travel transaction request basis, or may be part of a set of travel related default preferences associated with the user (e.g., the travel transaction related preferences discussed above in conjunction with FIG. 2, step 230). The transport transaction of step 310 may also comprise one or more requester preferences relating to a driver characteristic and/or a driver vehicle characteristic.

The transport transaction request of step 310 may be entered into a computing device, such as computing device 102 of FIG. 1, a mobile computing device 103 of FIG. 1, or the like. The computing device used to generate the transport transaction request of step 310 may be capable of determining the current location of the user. This location information may be used to form the request of step 310 (e.g., may automatically populate the starting position of the request).

At step 315, the transport transaction request may be sent to the transport transaction service. The transport transaction request may comprise a user identifier and/or an authentication credential, such as a user name and password, a Public Key Infrastructure (PKI) signature and certificate, a media access control (MAC) value of the device used to transmit the request, or any other user identification and/or authentication data known in the art. This information may be used by the method 300 to identify and authenticate the identity of the requester.

At step 320, the transport transaction service may receive the request; access a user profile associated with the request; and may match the transport request with one or more drivers who are available to provide the requested transport within the user-provided thresholds. As discussed above, the transport transaction request may comprise user identification and authentication information. Method 300 may use this information to identify a user profile associated with the request. In addition, the authentication information in the request may allow method 300 to authenticate the identity of the sender of the request.

The identification and/or authentication information of the request received at step 320 may allow the transport transaction service to access a user profile associated with the request. As discussed above, each user authorized to use the transport transaction service may have a user profile. The user profile may include information about the user including, demographic information, requester and/or driver preferences, payment information, and the like. At step 320, the user profile associated with the request may be accessed, and the user information may be read therefrom.

In addition, at step 320, a database comprising users of the system available to provide transport services may be searched to find a user capable of fulfilling the request. As discussed above, the transport transaction service may comprise a schedule database comprising the transport schedules of various users of the system. The schedule database may comprise user availability information where users may provide general availability areas and/or times that the user may be available to provide transport services (e.g., within 5 miles of City X from 7:00 a.m. to 9:00 p.m.). In addition, the schedule database may comprise real-time driver availability and location information. As discussed above, users of the system may provide real-time updates regarding their location and availability to provide transport services. This may be done manually (e.g., by manually transmitting location and availability information to the service) or may be automatic (e.g., the user may carry a location-aware mobile computing device and/or user a location-aware vehicular computing device). The real-time availability information may be useful where the request is for short-term or even immediate transport services.

The driver availability search of step 320 may comprise searching the driver database for any driver available to provide the requested transport transaction. The request may be for immediate transport or may be a request to schedule a future transport service. Alternatively, the request may be for a recurring transport service (e.g., transport from suburb B to city A every day at 9:00 a.m.). As such, the schedule database may comprise a searchable data storage system, such as an SQL server, an XML data store, an X.509 directory, and/or LDAP directory or the like. The schedule database may comprise a data structure capable of supporting search functionality (e.g., use of searchable data fields, SQL keys, or the like).

At step 325, results from the search may be obtained. If the search indicates that there are one or more drivers available to provide the requested transport service, the flow may continue to step 330. Otherwise, the flow may continue to step 390 where the user may be informed that no available drivers were found.

At step 330, the transport transaction service may compare one or more of the requester's preferences to each of the drivers found at step 320. As discussed above, a user profile may comprise one or more requester preferences. Alternatively, or in addition, one or more requester preferences may be sent with the transport transaction request of step 310. These requester preferences may be used to allow the requester to control the types of transport providers (e.g., drivers) the passenger will interact with in the transport transaction system. For example, if the requester is a young female who does not feel comfortable accepting transport from older male drivers, she may establish and/or transmit a requester preference indicating that she should not be matched to male drivers above a certain age. Similarly, if the passenger is uncomfortable accepting transport from a driver who has had a criminal conviction, a requester preference may be used to prevent the user from being matched with any driver having a criminal record. As discussed above, the requester preferences may comprise preferences relating to a driver characteristic (e.g., a driver demographic, or the like) and/or a driver vehicle characteristic (e.g., vehicle type, emissions level, engine type, or the like).

One or more of the requester preferences may be mandatory. A mandatory preference may be one that the driver and/or driver vehicle must meet in order for the driver to be selected at step 330. For example, a user may establish a mandatory requester preference that the driver may not have a criminal record. In this case, any driver who has a criminal record will not be selected at step 330. Alternatively, some preferences may be non-mandatory (e.g., optional). These preferences may be used to order the set of conforming drivers. For example, the passenger may establish a non-mandatory preference towards drivers who use hybrid and/or low emission vehicles. As such, a driver of a non-hybrid may be matched to the passenger at step 330. However, the non-hybrid driver may be offered the transaction only after other “hybrid” driving drivers are offered the transaction.

In addition, one or more of the driver and/or driver vehicle characteristics may be required to be verified by a third-party. A verified preference may be one that must be verified by a third-party in order for the driver to be selected at step 330. For example, a user may establish a verified preference that the driver has less than a threshold number of points on his/her driving record, and that this preference must be validated by a third-party. As such, a matching driver must not only have a preference indicating that he/she has fewer than the threshold number of points on his/her license, but also that the information be verified by a third-party (e.g., by the transport transaction service, a governmental agency, or the like).

At step 335, the method 300 may determine whether any of the drivers identified at step 320 comply with the requester's preferences. If so, the flow may continue to step 340; otherwise, the flow may terminate at step 390 where the passenger may be informed that no conforming drivers were found for the transaction. The message at step 390 may indicate the reason that no drivers were found (e.g., that one or more drivers did not conform to one or more of the requester preferences).

At step 340, each of the drivers identified at step 330 may be evaluated to determine whether the passenger conforms to each driver's preferences. As discussed above, users of the transport transaction service may establish both passenger and driver preferences. At step 340, method 300 may determine whether the driver preferences of each driver are compatible with a user profile of the requester. As discussed above in conjunction with step 330, driver preferences may relate to characteristics of the passenger (e.g., passenger demographics or the like) and may be mandatory or non-mandatory. If the passenger does not conform to a mandatory reference, the driver may be removed from consideration at step 340. If the passenger does not conform to a non-mandatory preference, the driver may only be offered the transport transaction after other drivers have rejected the transaction. Similarly, driver preference may be marked as requiring third-party verification. In addition, when the offer of the transport transaction is made to the driver, the driver may be informed that the passenger does not conform to the preference. The driver may use this nonconformance to determine whether he/she wishes to accept the transport transaction. Also see steps 350, 355.

At step 345, method 300 may determine whether any conforming drivers remain available to provide the requested transport transaction. If so, the flow may continue to step 350; otherwise, the flow may terminate at step 390 where the passenger may be informed that no conforming drivers were found. The message at step 390 may also indicate the reason that no drivers were matched (e.g., because the passenger did not conform to a driver preference). In addition, at step 390, one or more of the drivers may be informed that a transaction was rejected due to one or more of their driver preferences. This may give the driver the opportunity to perhaps broaden his/her preferences to allow for more frequent matches.

At step 350, the transport transaction may be offered to one or more of the conforming drivers determined at step 340. As discussed above, the driver and passenger preferences may include non-mandatory preferences. These preferences may be used to order the list of conforming drivers. For example, if there were five conforming drivers found at step 340, and two of the drivers conformed to non-mandatory preferences while the other three did not, the two conforming drivers may be offered the transaction before the three non-conforming drivers. Similarly, a preference may comprise “proximity” preferences (e.g., preferred driver age of 30, insurance coverage of one million, etc.). The drivers closest to the preferred characteristic (e.g., closest to 30 and/or insurance coverage of one million, or the like) may be offered the transaction before other conforming drivers.

The offer at step 350 may comprise transmitting a message to the one or more conforming drivers. The message may specify the transport transaction preferences (e.g., the preferred starting point, ending point, pickup and/or delivery time, and price). The message may comprise an acceptance window indicating that the driver must accept or decline (by default) the transaction within a specified time period. The driver may accept the offer by responding to the message. Where multiple transport transaction offers are transmitted simultaneously, the offer message may indicate that the offer is valid only for the first driver to accept. Where the drivers are ordered by, for example, a passenger and/or driver preference, the preferred drivers may be offered, and given a chance to accept or reject the transaction before other drivers.

The offer of step 350 may allow the driver to modify terms of the transaction within transport transaction related thresholds. As discussed above, these thresholds may include an acceptable change to the starting point, ending point, pickup and/or delivery time, and price. In one embodiment, the driver may make changes to the offer and thereby accept the offer. In another embodiment, modified offers may be accepted contingent upon approval by the passenger.

In another embodiment, the offers of step 350 may allow the drivers to modify the price of the transaction. In this case, the offer message may comprise an offered price of the transaction. The driver may provide a bid price in a provisional acceptance message. The passenger may receive the various bids, and select the preferred bid. The bids may also include a starting point, ending point, and a pick and/or delivery time. In some cases, the passenger may be willing to accept a higher priced bid if the transaction is more favorable (e.g., closer starting point, ending point, or the like) and/or if the bid is from a preferred driver (e.g., a driver who conforms to one or more non-mandatory preference).

The driver offer messages may be transmitted to the driver over a network to a computing device, mobile computing device, and/or vehicular computing device used by the driver. The driver may transmit the acceptance using the appropriate device. Alternatively, the driver offer message may be transmitted in another form, such as an email message, a voice message, a text message, an SMS message, or the like. The message may go to another type of device, such as a phone, cellular phone, or the like. The acceptance may comprise a message transmitted via email, text, SMS, Internet, or any other communication means known in the art.

At step 355, method 300 may determine whether any driver acceptances were received. If so, the flow may continue to step 360; otherwise, the flow may terminate at step 390 where the passenger may be informed that no drivers accepted the transport transaction offer. Where the rejections were due to a low offered price, the passenger may be so informed so that the passenger may adjust his/her transport transaction preferences accordingly.

At step 360, the requester may be provided an opportunity to accept one of the received driver acceptances. Where the driver acceptance is non-provisional (e.g., for a set price and within the transport transaction thresholds), step 360 may not be necessary, and the flow may continue to step 365. However, where the offer from the driver is a bid, significantly changes the starting point, ending point, and/or price, the passenger may be given the opportunity to approve the driver acceptance at step 360. Similarly, where multiple bids are received, the requester may select one of the bids at step 360. If the passenger approves the driver acceptance at step 360, the flow may continue to step 365. Otherwise, the flow may continue to step 355, where additional driver offers may be made.

At step 365, a record of the accepted transport transaction may be stored in a data storage system. In addition, the schedule of the driver and/or passenger may be updated to reflect the transport transaction. This may comprise blocking out the transport time on a driver's schedule and/or indicating on the driver's schedule that transport is to take place from the agreed upon starting point, ending point, and pickup and/or delivery time. This may allow subsequent transport requests to be matched to the existing transaction. For example, if driver D is already providing transport to a requester P1 from suburb B to city A, an additional requester P2 with similar transport needs may be matched to the trip. This may allow both requesters to share in the cost of the transport and further reduce traffic congestion. Alternatively, the requester may prefer the transport to be exclusive. If so, no additional passengers may be added to the transport transaction.

At step 370, a confirmation message may be transmitted to the requester and the driver. The confirmation message may include the agreed upon transport transaction preferences (e.g., the starting point, ending point, pickup and/or delivery time, and price). In addition, driver and/or passenger identifying information may be exchanged. For the passenger, this may comprise an image of the driver's vehicle, a license plate number of the driver's vehicle, or any other driver identifying information. This may allow the passenger to readily identify the driver, making for a smoother transport transaction. In addition, the driver may be provided with passenger identifying information, such as a photograph, moniker (e.g., a real or alias name of the passenger), or any other passenger identifying information. The passenger and driver may control what identifying information is provided to other parties.

In addition, prior to step 375, method 300 may cause a reminder message to be transmitted to the passenger and/or driver as the transaction is to take place. The message may comprise a location of the driver and/or passenger. This may be possible if the passenger and/or driver possesses a location aware computing device (e.g., mobile computing device, vehicular computing device, cell phone, or the like). Alternatively, the passenger and/or driver may manually inform method 300 of their location. In this way, the passenger and/or driver may monitor the progress of the other party as the time for the transaction nears (e.g., the passenger may determine how close the driver is to the starting point). In addition, where method 300 is aware of the driver's location, method 300 may transmit an alert message to the passenger when the driver enters a proximity (e.g., geofence range) of the starting point. The messages described in conjunction with step 375 may comprise digital message (e.g., webcontent, email, video, or the like), and/or may comprise text, voice, SMS, message transmitted to a computing device and/or phone.

At step 375, the transport transaction may take place. In some embodiments, where the requester or driver may possess a mobile computing and/or vehicular computing device configured to periodically transmit the location of the passenger and driver to the transport transaction service. This may allow a third-party (e.g., the parent of the passenger or driver) to monitor the transport transaction.

At step 380, a notification message may be transmitted to the requester and/or a third party to alert the requester and/or third party to the arrival of the passenger, goods, and/or documents. As discussed above, in some embodiments, the location of the passenger and/or driver may be monitored during the transport transaction. This may be done using a location-aware mobile computing device. The passenger, driver, goods, and/or documents may posses a location-aware device such as a GPS device, cell-phone, a PDA, or the like. The location-aware device may be in communication with the transport transaction service and may be configured to periodically transmit a location of the passenger, driver, goods, and/or documents to the transport transaction service. Alternatively, the passenger and/or driver may periodically, manually update their location by transmitting a location (e.g., address) to the transport transaction service. In such embodiments, the transport requester may specify that a notification message be transmitted to the requester or another third party when the driver arrives within a proximity of the ending point of the transport transaction (e.g., a geofence defined by the ending point and a proximity threshold). The message may comprise a notification to the requester and/or the third party that the passenger, goods, and/or documents are about to arrive at the ending point. The message may allow the requester and/or third-party to prepare for the arrival of the passenger, goods, and/or documents.

In addition, at step 380, after the transport transaction is completed, the driver and/or requester may provide a rating of the transport transaction. The rating may provide feedback on various aspects of the transport transaction including, but not limited to: timeliness of the passenger and/or driver, cleanliness of the vehicle, conversation, ambiance, safety, driving style, driving speed, route, and the like. Also at step 380, a payment may be transferred from the passenger to the driver. Where the payment information is stored in the passenger user profile, payment may be automatic. Alternatively, the passenger may pay cash or the like, directly to the driver. In an alternative embodiment, the transport transaction system may comprise a credit/debit system for providing transport services. Providers of transport services may receive “credits” for providing transport services, and passengers may be debited for receiving transport services. Thus, drivers may earn the right to future transport services by providing services to other users, and vice versa and/or may exchange their points for other services, goods, and/or cash.

In addition, in embodiments where the location of the passenger and/or driver is monitored during the transport transaction, the payment for the transport transaction may not be transferred until the transport transaction service detects that the passenger has arrived at the agreed-upon ending point of the transport transaction. Similarly, where the transport transaction comprises the transport of goods and/or documents, the payment for the transport transaction may not be transferred until a recipient of the goods and/or documents transmits an acknowledgement to the transport transaction service and/or the transport transaction service detects that the goods and/or documents have arrived at the ending point (e.g., if the goods and/or documents include a location tracking device, such as a GPS location transmitter).

At step 385, the flow may terminate.

Although the process 300 is described primarily in the context of a passenger receiving transport from a driver, one skilled in the art would recognize that other transport services, such as delivery of goods, documents and the like could be provided under the teachings of this disclosure.

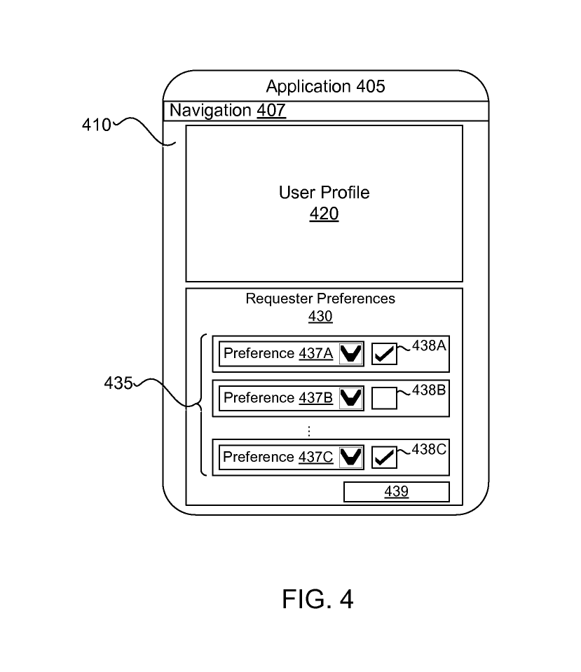

FIG. 4 depicts one embodiment of a user interface 400 configured to allow a user of a transport transaction service to establish a user profile comprising one or more requester preferences. Application 405 may comprise web browser software, such as Microsoft™ Internet Explorer™, Mozilla Firefox™, Opera™, or the like. Application 405 may be configured to display content formatted according to an HTML, Extensible Markup Language (XML), and/or another standard. In an alternative embodiment, application 405 may comprise a custom application dedicated to providing transport transaction services. Application 405 may comprise navigation component 407 which may be used to enter a uniform resource identifier (URI) to access a web site (e.g., a server communicatively coupled to a network, such as the Internet) and/or to navigate within a web site and/or network. The URI may be formed according to RFC 1630, 1738, 2396, 2732, 3986, or a related standard and may comprise a domain name indicator (e.g., www.example.com) which may be used to access content located on a network.

Application 405 may comprise a display 410 wherein data, such as HTML or other renderable data, may be presented to a user. The display 410 may comprise interface 412. Interface 412 may provide browsing and/or searching functionality to allow users of Application 405 to access content on the web site, service, and/or network. As such, interface 412 may comprise a search component (not shown) to allow a user to search for a content in the website or service using application 405.

The website displayed in display 410 of application 405 may comprise a transport transaction service application. As discussed above, the transport transaction service may allow users to establish and/or update a respective user profile. User profile information may be input into user profile input 420 on display 410. The user profile input 420 may accept user contact information, payment information, demographic information, driving record information, whether the user is available as a driver, and the like.

The user profile information 420 may also comprise a requester preference input 430. The input 430 may allow a user to establish one or more requester preferences 437A, 437B, and 437C. Input 430 may allow the user to indicate whether the preference 437A, 437B, and/or 437C is mandatory or optional. For example, a check box input 438A, 438B, and/or 438C may be used to specify that a particular preference 437A, 437B, 437C is mandatory (e.g., in FIG. 4, preferences 437A and 437C may be mandatory). Alternatively, inputs 438A, 438B, and 438C may comprise a range input to indicate a relative importance and/or priority of preferences 435. The requester preference input 430 may comprise a control 439 to allow a user to add, delete, and/or modify preferences 435 in the user profile.

In addition, the user may indicate that the preference 437A, 437B, and/or 437C must be verified. In some embodiments, the transport transaction service may independently verify user profile information. For example, the transport transaction service may contact a user's insurance company to verify that the user is insured and determine the user's coverage limits. A criminal record of a user may be verified with a governmental agency. A user's credit report may be checked against a credit reporting agency. Similarly, social security and/or birth records may be used to verify a user's gender, age, and the like.

In some embodiments, input 430 may allow a user to specify that a particular requester preference is only to match if the corresponding driver attribute has been verified by the transport transaction service or some other third party. This may provide an additional level of assurance to the passenger. Although not depicted in FIG. 4, the validation requirement could be included as a check box associated with the preference 437A, 437B, and 437C as used for inputs 438A, 438B, and 438C.

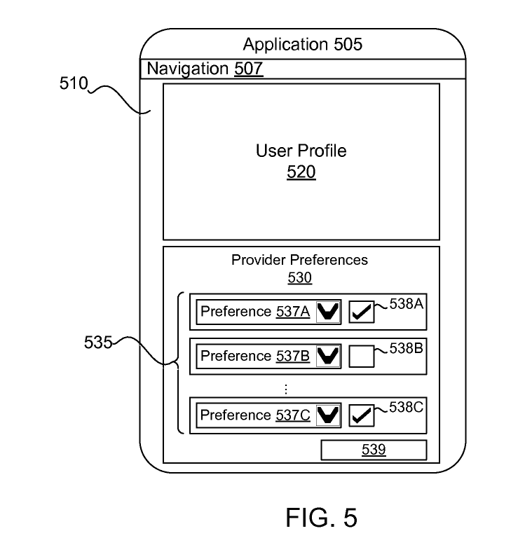

FIG. 5 depicts one embodiment of a user interface 500 configured to allow a user of a transport transaction service to establish a user profile comprising one or more driver preferences 535. Application 505 may comprise web browser software, such as Microsoft™ Internet Explorer™, Mozilla Firefox™, Opera™, or the like. Application 505 may be configured to display content formatted according to an HTML, Extensible Markup Language (XML), and/or another standard. In an alternative embodiment, application 505 may comprise a custom application dedicated to providing transport transaction services. Application 505 may comprise navigation component 507, which may be used to enter a URI to access a website (e.g., a server communicatively coupled to a network, such as the Internet) and/or to navigate within a website and/or network.

Application 505 may comprise a display 510 wherein data, such as HTML or other renderable data, may be presented to a user. Display 510 may comprise interface 512. Interface 512 may provide browsing and/or searching functionality to allow users of Application 505 to access content on the website, service, and/or network. As such, interface 512 may comprise a search component (not shown) to allow a user to search for a content in the website or service using application 505.

The website displayed in display 510 of application 505 may comprise a transport transaction service application. As discussed above, the transport transaction service may allow users to establish and/or update a respective user profile. User profile information may be input into user profile input 520 on display 510. The user profile input 520 may accept user contact information, payment information, whether the user is available as a driver, driver scheduling and availability information, and the like.

The user profile information 520 may also comprise a driver preference input 530. The input 530 may allow a user to establish one or more driver preferences 537A, 537B, and 537C. Input 530 may allow the user to indicate whether the preference 537A, 537B, and/or 537C is mandatory or optional. For example, a check box input 538A, 538B, and/or 538C may be used to specify that a particular driver preference 537A, 537B, 537C is mandatory (e.g., in FIG. 5, driver preferences 537A and 537C may be mandatory). Alternatively, inputs 538A, 538B, and 538C may comprise a range input to indicate a relative importance and/or priority of preferences 535. The driver preference input 530 may comprise a control 539 to allow a user to add, delete, and/or modify preferences 535 in his/her user profile.

Although the user profile interface depicted in FIG. 4 and FIG. 5 the depicts requester preference input 430 as separate from the driver preference input 530, one skilled in the art would recognize that both inputs could be displayed simultaneously on display 410 and/or 510.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a computer-readable medium having stored thereon instructions that may be used to program a computer (or other electronic device) to perform processes described herein. The computer-readable medium may include, but is not limited to, hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention. The scope of the present invention should, therefore, be determined only by the following claims.

I claim:

1. A computer-readable medium comprising program code to cause a computer to perform a method for arranging a transport transaction for a requester, the method comprising:
receiving a set of transport preferences comprising a desired starting point, ending point, and pickup and/or delivery time;
accessing one or more requester preferences relating to driver characteristics and/or driver vehicle characteristics;
searching a plurality to drivers to determine a first set of drivers available to provide transportation in accordance with the transport preferences;
selecting from the first set of drivers a second set of drivers based on the one or more requester preferences; and
offering at least one driver in the second set of drivers to provide the transportation in accordance with the transport preferences.

2. The computer-readable medium of claim 1, wherein a requester preference relates to a driver demographic characteristic.

3. The computer-readable medium of claim 1, wherein a requester preference relates to a driver vehicle emission and a driver vehicle engine type.

4. The computer-readable medium of claim 1, wherein a requester preference is verified by a third party.

5. The computer-readable medium of claim 4, wherein a verified requester preference relates to a driver insurance coverage limit.

6. The computer-readable medium of claim 4, wherein a verified requester preference relates to a driver driving record.

7. The computer-readable medium of claim 4, wherein a verified requester preference relates to a driver criminal record.

8. The computer-readable medium of claim 1, wherein the method further comprises retaining only those drivers in the second set of drivers whose driver preferences relating to one or more passenger characteristics conform to a passenger profile of the requester.

9. The computer-readable medium of claim 8, wherein a passenger characteristic relates to a passenger demographic characteristic.

10. The computer-readable medium of claim 8, wherein a passenger characteristic is verified by a third party.

11. The computer-readable medium of claim 10, wherein the verified passenger characteristic relates to one selected from the group consisting of a passenger credit score and a passenger criminal record.

12. The computer-readable medium of claim 1, wherein the transport preferences comprise one selected from the group consisting of a starting point proximity threshold, an ending point proximity threshold, and a pickup and/or delivery time proximity threshold.

13. The computer-readable medium of claim 1, wherein the transport preferences comprise a desired price.

14. The computer-readable medium of claim 1, wherein the method further comprises receiving an acceptance from a first driver.

15. The computer-readable medium of claim 14, wherein the method further comprises transmitting a confirmation to the requester, comprising:
a starting point, and
a pickup and/or delivery time.

16. The computer-readable medium of claim 15, wherein the starting point comprises a location coordinate.

17. The computer-readable medium of claim 15, wherein the method further comprises transmitting a reminder message to the requester prior to a pickup time for the transport transaction comprising a vehicle identifier to assist the requester in identifying the first driver.

18. The computer-readable medium of claim 17, wherein the vehicle identifier comprises one selected from the group consisting of an image of a vehicle and a license plate number of a vehicle.

19. The computer-readable medium of claim 17, wherein the method further comprises:
detecting a proximity of the first driver to the starting point; and
transmitting an alert message to the requester to alert the requester to the first driver's proximity.

20. The computer-readable medium of claim 14, wherein the acceptance comprises a bid for the travel transaction by a driver, and wherein the method further comprises:
transmitting a plurality of driver acceptances to the requester for selection by the requester; and
receiving an acceptance from the requester selecting a driver acceptance.

21. A system for arranging a transport transaction, comprising
a communication module to receive a transport request from a requester comprising a desired starting point, ending point, and pickup and/or delivery time;
a user manager module communicatively coupled to the communication module to access a user profile of the requester, wherein the user profile comprises one or more requester preferences relating to a driver characteristic and/or a driver vehicle characteristic; and
a transaction manager module communicatively coupled to the user manager module and the communication module to search a user database to determine a first set of drivers available to provide transport in accordance with the transport preferences and to select from the first set of drivers a second set of drivers based on the one or more requester preferences,
wherein the communication module is to transmit an offer to provide the transport to at least one driver in the second set of drivers.

22. The system of claim 21, wherein a requester preference relates to a driver demographic.

23. The system of claim 21, wherein a requester preference is verified by a third-party.

24. A system for arranging a transport transaction for a requester, comprising:
means for receiving a set of transport preferences comprising a desired starting point, ending point, and pickup and/or delivery time;
means for accessing one or more requester preferences relating to a driver characteristic and/or a driver vehicle characteristic;
means for searching a plurality to drivers to determine a first set of drivers available to provide transportation in accordance with the transport preferences;
means for selecting from the first set of drivers a second set of drivers based on the requester preferences; and
means for offering at least one driver in the second set of drivers to provide the transportation in accordance with the transport preferences.

25. The system of claim 24, wherein a requester preference relates to one selected from the group consisting of a driver hobby, a driver religion, a driver political persuasion, and a driver interest.
